(19) United States
(12) Patent Application Publication
(10) Pub. No.: US 2018/0072046 A1
(43) Pub. Date: Mar. 15, 2018

(54) ALIGNMENT INDICATOR FOR REGISTRATION SYSTEM

(71) Applicant: M&R Printing Equipment, Inc., Roselle, IL (US)

(72) Inventors: Richard C. Hoffman, JR., Lake Forest, IL (US); Andrew L. Oleson, Carol Stream, IL (US); Keith R. Falk, Cary, IL (US); Darek Tkacz, Naperville, IL (US)

(21) Appl. No.: 15/700,672

(22) Filed: Sep. 11, 2017

Related U.S. Application Data
(60) Provisional application No. 62/393,290, filed on Sep. 12, 2016.

(51) Int. Cl. B41F 33/00; B41F 15/34; B41M 1/12; B41F 33/02

(52) U.S. Cl. CPC B41F 33/0081; B41F 33/02; B41M 1/12; B41F 15/34

(57) ABSTRACT

An indicator system is provided for ensuring proper registration of a frame. A plurality of stops for a registration system are electrically coupled to each other. When contact is made with a metal frame, a circuit is created and an indicator coupled to the circuit, such as a light, can be activated to show such contact.

### CROSS-REFERENCE TO RELATED APPLICATIONS

The present invention claims the benefit of U.S. Provisional Patent Application No. 62/393,290 filed Sep. 12, 2016, the contents of which are incorporated herein by reference.

### FEDERALLY SPONSORED RESEARCH OR DEVELOPMENT

N/A

### FIELD OF THE INVENTION

The present invention generally relates to an indicator system for determining if a frame is in proper registration in a printing apparatus, and more particularly to a pallet or bed for a screen printing apparatus having a three-point registration system with one or more indicators, such as an LED light, to confirm proper registration of the screen.

### DESCRIPTION OF THE PRIOR ART

Screen printing requires precise alignment or registration of the screen printing screens used in a printing operation. This can occur when creating the screen as well as during use in a printing operation. If the screens are not properly registered, the design printed on a textile can suffer (e.g., blurred image, edging from underlying colors showing, etc.).

One system for ensuring proper registration of a silk screen is shown in U.S. Pat. No. 5,953,987. This system provides a pallet having three stopping points for positioning the frame of a silk screen. The pallet is typically used in a turret of a printing apparatus. When the screen is pressed against the stopping points, it is then clamped to the pallet. Modern printing apparatus can be configured with hydraulic clamping devices to achieve this result.

While the three stopping point system improved registration, in some instances it was possible for the frame to be very close to, but not in contact with the one or more of the stops. Moreover, in such instances, the lack of contact was often not visually perceptible. For example, the frame could be within a few millimeters or less of the stopping point (e.g., the thickness of a piece of paper), but not touching it. Even though registration was off by only a small amount, the resulting printed design or image would suffer; appearing blurry and/or having a first color appear to outline another color along an edge.

The present invention enhances the prior system using stop points by providing an indicator system to insure proper contact between the screen frame and the stop points.

### SUMMARY OF THE INVENTION

The present invention is directed to an indicator system for assuring proper alignment and registration of a silk screen frame in a printing apparatus. The system can be deployed in a support surface of an apparatus, or on a pallet for use with an apparatus.

In accordance with one aspect of the invention, an indicator system for registering a frame on a pallet for use in a printing apparatus is provided. The system comprises a pallet support formed from a non-conductive material having a top surface and a lower surface. A first stop is connected to one end of the support and extends upward from the top surface of the support. A second stop is connected to a second end of the support and also extends upward from the top surface of the support. A conductive element connects the first stop and second stop. A first indicator is coupled to the second stop. A complete circuit is formed when the first stop and second stop contact the frame of a silk screen. When this occurs, the indicator is activated and provides an indication to an operator that contact is made. A power source, such as a battery, can be coupled to the circuit to provide power for the indicator.

The first indicator can be a light, such as an LED. Alternatively, or along with the light, the first indicator can be an audible alert, or another mechanism for providing an alert (e.g., a vibrating mechanism).

The system can further comprise a third stop connected to the support proximate the second stop that is electrically coupled to the first stop. The third stop can also extend upward from the top surface of the support and include a second indicator. Additional stops can be added in like manner.

The conductive element can be a plate connecting the first stop to the second stop (and the first stop to the third stop or additional stops). The conductive element can be connected to the bottom surface of the support, embedded in the support, or run along an edge of the support. Alternatively, the conductive element can be a wire.

The first indicator can be connected to or on the second stop. Alternatively, the first indicator can be remote from the second stop.

In accordance with another aspect of the invention, an indicator system for ensuring proper registration is provided. The system comprises a plurality of stops electrically coupled to each other where each stop includes a contacting surface for contacting a frame. At least a first indicator is electrically coupled to the stops. The first indicator is activated when a complete circuit is made with at least two of the stops and a frame.

The plurality of stops and the first indicator can be connected to a printing pallet. Alternatively, the plurality of stops and the first indicator can be connected directly to a support surface of a printing apparatus.

In accordance with another aspect of the invention, a printing apparatus having an indicator system for registering a frame is provided. The apparatus comprises a support surface for receiving a frame, a first stop connected to the support surface and a second stop connected to the support surface. The second stop is electrically coupled to the first stop. A first indicator is electrically coupled to the first stop and second stop. The first indicator is activated when a circuit is created between the first stop, the second stop and a frame. Again a power source can be provided for powering the indicator. In this instance, the power source of the apparatus can be used if desired.

The apparatus can further comprise a controller coupled to the apparatus for controlling printing operation. The controller can also be electrically coupled to the stops and configured to prevent a printing operation if the first indicator is not activated (that is, if contact is not sensed with the frame—in this instance, completion of the circuit provides indication to the controller of contact, and no indicator that can be sensed by the operator is necessary). If desired, a display coupled to the controller can provide indication to the user that contact is made.

Again, a third stop (or more stops) can be electrically coupled to the first stop and a second indicator (or more) can be provided.

Further aspects of the invention are disclosed in the Figures, and are described herein.

### BRIEF DESCRIPTION OF THE DRAWINGS

To understand the present invention, it will now be described by way of example, with reference to the accompanying drawings in which:

FIG. 1 is a top perspective view of a pallet for use with a screen printing apparatus having a registration indicator system in accordance with the present invention;

FIG. 2 is a bottom perspective view of the pallet of FIG. 1;

FIG. 3 is a top perspective view of the pallet of FIG. 1 with a screen frame in proper registration;

FIG. 4 is a top perspective view of the pallet and screen of FIG. 3 with the screen out of proper registration;

FIG. 5 is a top perspective view of a pallet for use with a screen printing apparatus having a registration indicator system in accordance with the present invention; and,

FIG. 6 is a top perspective view of a screen printer having a registration indicator system in accordance with the present invention.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

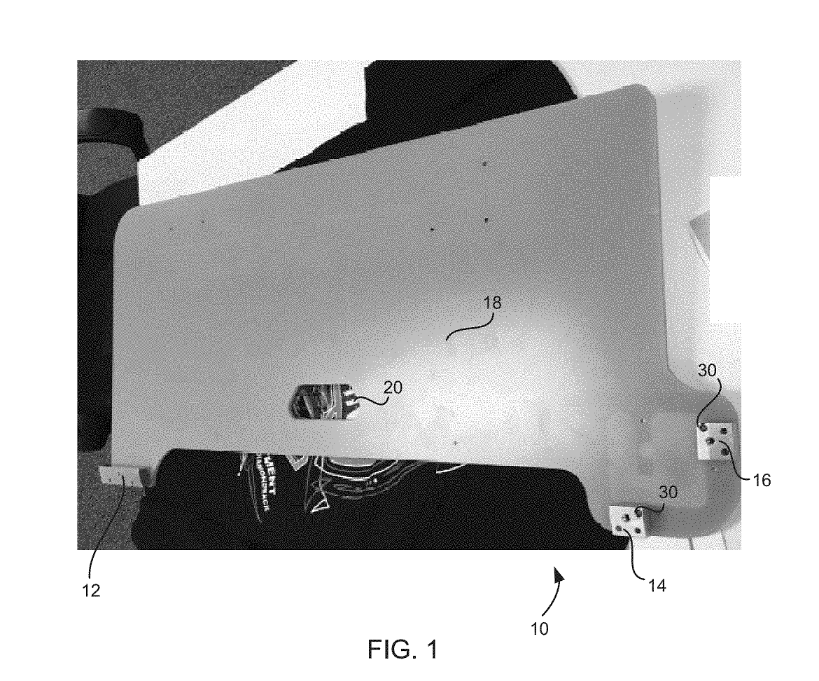

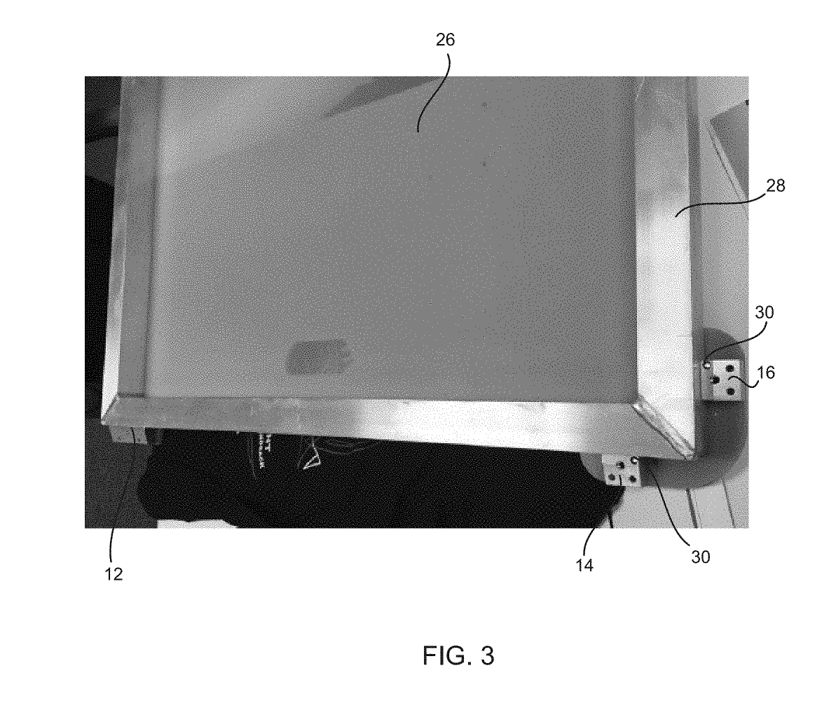

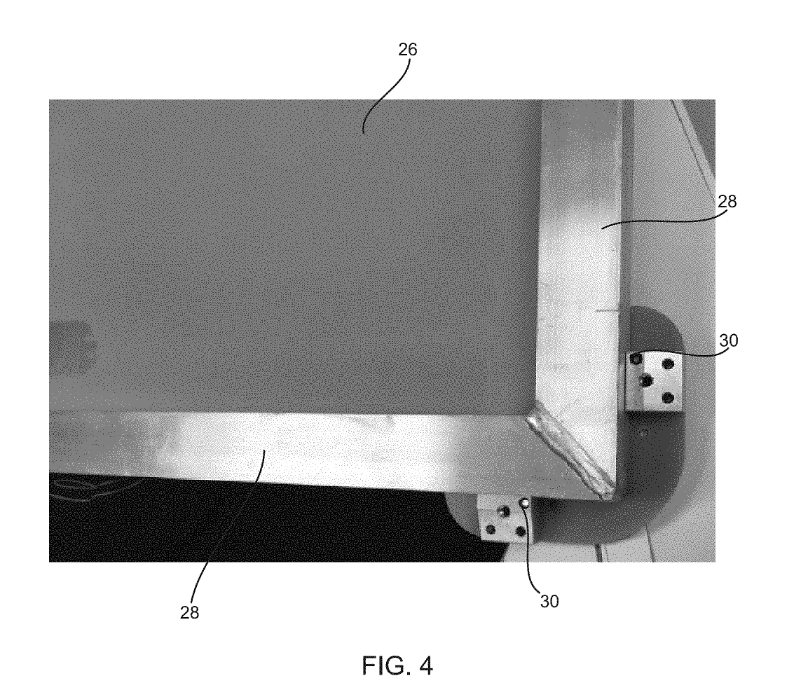

FIG. 1 shows an upper surface of a printing pallet 10 for receiving a frame holding a silk screen (shown in FIGS. 3 and 4) in accordance with the present invention. The pallet 10 includes a first stop block 12 (or sometimes simply “stop”) at one end, a second stop block 14 and a third stop block 16, at an opposing end. Each of the stops 12, 14, 16 is formed from a conductive material (e.g., aluminum) or has a conductive surface for contacting the screen frame. The remainder of the pallet 10 is a flat support portion 18 having an upper surface and a lower surface, formed from a non-conductive material, such as plastic, or otherwise electrically insulated from the stops 12, 14, 16 (or the conductive contacting surfaces thereof). The support 18 includes a handle 20. The stops 12, 14, 16 can be screwed, bolted or otherwise connected or secured to the support 18.

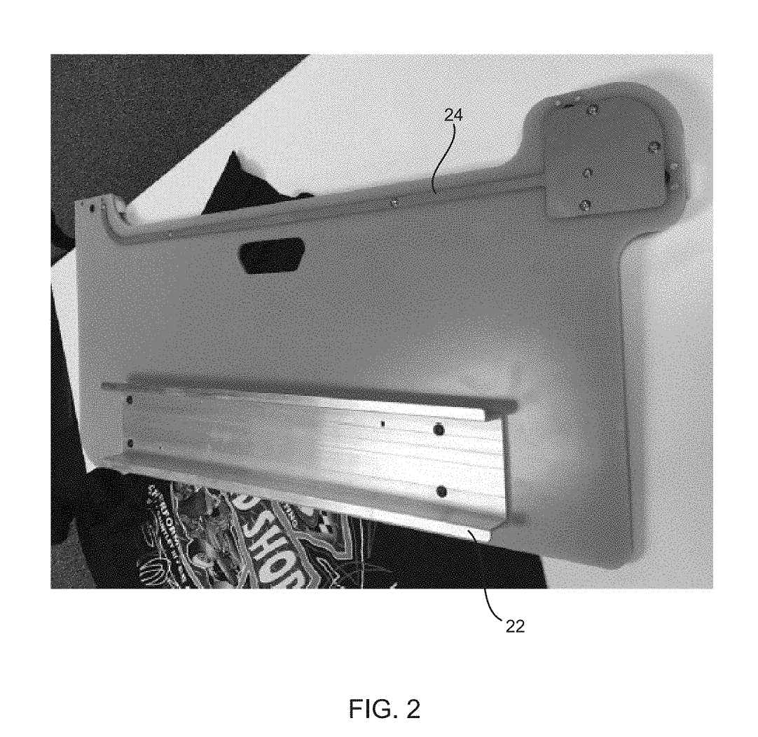

FIG. 2 shows the lower surface of the pallet 10. The lower surface of the pallet 10 includes a mounting bracket 22 attached to the pallet 10 for securing the pallet 10 to a printing apparatus (or other apparatus used for printing textiles). The lower surface of the pallet 10 also includes an electrically conductive plate 24 extending from one end of the pallet 10 to the other. The electrically conductive plate 24 electrically connects or couples the first stop 12 to the second stop 14 and the third stop 16. The stops 12, 14, 16 include a portion (or are electrically coupled to an element) that extends through the thickness of the support 18 to contact the conductive plate 24. While FIG. 2 shows the conductive plate 24 secured to the lower surface of the support 18, it can be embedded in the support 18 or otherwise positioned on the pallet 10 (e.g., running along an edge of the support 18).

The electrically conductive plate 24 is used to create an electronic circuit when the stops 12, 14, 16 contact the edge of a silk screen frame (the frames are typically held in metal frames, such as aluminum; if a non-conductive frame is used, a conductive strip is required along the edges of the frame). The circuit can be used to activate an indicator (such as an LED light) to clearly demonstrate the frame 28 is contacting at least two of the stops. This is illustrated in FIGS. 3 and 4.

FIG. 3 shows a silk screen 26 in a frame 28 positioned on top of the support surface 18 of the pallet 10. The frame 28 is formed from aluminum and creates an electric circuit between the first stop 12 and the second stop 14, as well as between the first stop 12 and the third stop 16, or between all three stops 12, 14, 16 when it contacts the stops. A battery, either embedded in or otherwise electrically coupled to a stop, can be used to power an indicator to show that the frame is in fact contacting the stop (alternative a power source from the printing apparatus or elsewhere can be coupled to the pallet or directly to the stops to provide power for the circuit). Preferably, thin watch type batteries can be used. Each of the second and third stops 14, 16 include an LED 30 as an indicator. As illustrated in FIG. 3, the LED 30 in each stop 14, 16 is “on” indicating the frame 28 is contacting both the first stop 12 and the second and third stops 14, 16. When the frame 28 is properly positioned (i.e., in registration) and the indicator LED's 30 are “on,” the frame 28 can be clamped into place on the pallet 10. The printing apparatus can have hydraulic clamps for this purpose.

As discussed above, in some instances the frame 28 can be an almost imperceptible distance from the stop. This is illustrated in FIG. 4 which shows an “on” LED 30 in the second stop 14, and an “off” (i.e., unlit) LED 30 in the third stop 16. This slight difference from proper registration position can cause problems in the design applied to the textile in the screen printing apparatus. Because the LED 30 in the third stop 16 is “off,” the operator knows correction is needed before clamping the frame 28 to the pallet 10.

While an LED indicator is shown in the Figures, other indicator devices can be used. This might include an audible component (such as a speaker) or a vibrating indicator. The indicators can be used separately or combined with other types of indicators or controls. Moreover, the indicators can be located at different positions on the stops or elsewhere on the pallet 10 or printing apparatus where they may be more visible or accessible to a user or operator of the printing apparatus.

Additionally, the stops and/or indicators can be coupled (via wires or wirelessly) to a controller which can provide a display of the state of contact, and/or control operation of the printing apparatus depending on the state of contact (e.g., preventing printing operations if no contact is sensed in one or more of the stops).

While the present Figures show three stop points, the system could have two stop points or more than three stop points as desired or needed.

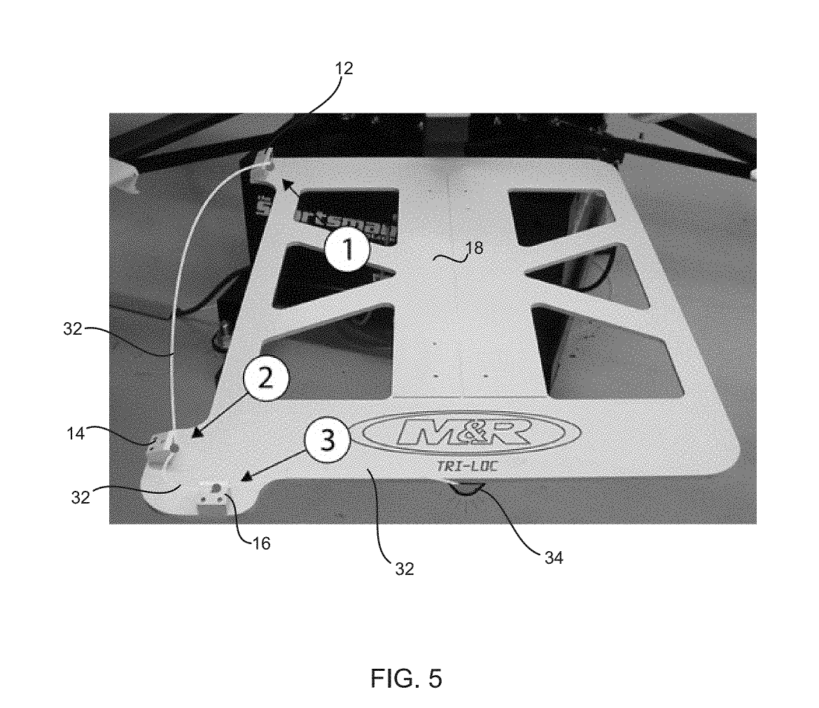

FIG. 5 shows another design of the present invention. In this configuration, the stops 12, 14, 16 (or at least the contacting surfaces of each stop) are electrically coupled by wires 32 extending between the stops 12, 14, 16. While the stops may include indicators on the stops (like the stops shown in FIGS. 1-4), a remote indicator 34 (e.g. an LED or other type of light) is connected to the stops by another wire 32. The remote indicator 34 is shown centrally located at an edge of the support 18. However, it can be placed anywhere it would be visible to an operator.

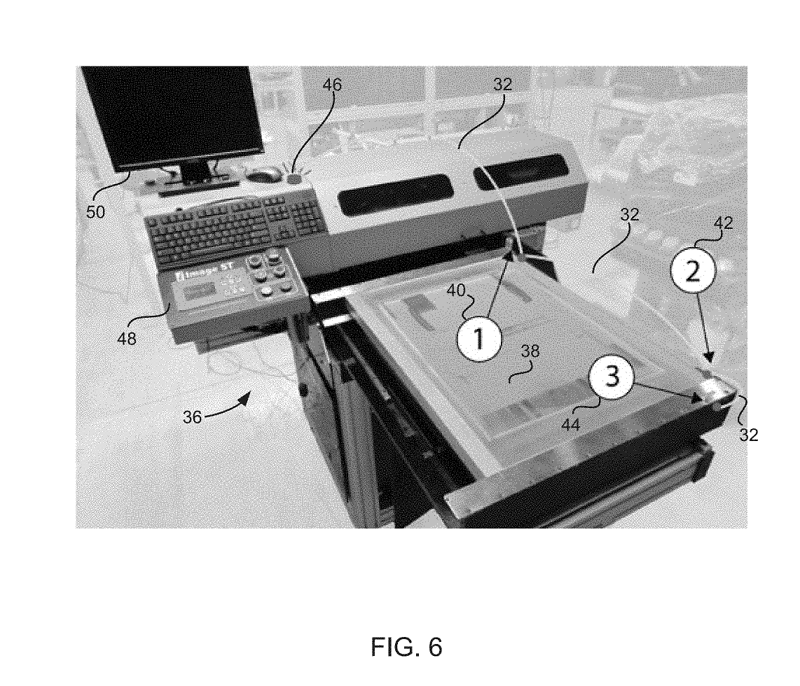

The present indicator system can also be utilized with or incorporated into other printing systems or apparatuses. As shown in FIG. 6, a digital screen printing apparatus 36 is shown having a screen frame support bed or surface 38. Stops 40, 42, 44 are shown connected by wires 32 (while “free” wires are shown, other electrical connections can be used or the wires can be inside the apparatus). A wire 32 connects the stops 40, 42, 44 to an indicator light 46 to establish when contact is made with the stops (similar to the pallet, each or select stops can have its own light so that it is easy to determine which stop is lacking contact with the frame). Again, a complete circuit is formed when the metal of the silk frame contacts the stops.

Additionally, the stops can be electrically coupled to a controller 48 of the apparatus 36 which includes a display 50. In this instance, the indicator light 46 can be optionally removed the display can be used as an indicator (again other visual and/or audible or other types of indicators can also be used). Connecting the stops 40, 42, 44 to the controller 48 can also allow the controller 48 to prevent printing if the screen frame is not properly registered. That is, if the screen frame does not properly contact the various stops 40, 42, 44, the controller 48 can display an error message and prevent or stop printing. In this version of the system, power from the apparatus 36 can be used to power the circuits created by the stops 40, 42, 44 and the screen frame.

The electrical circuit created by the stops can be a series connection. In this instance, a single indicator can be used to determine if the frame is contacting each of the stops in the series. Alternatively, the electrical connection can be created in parallel so that each stop has its own indicator that is triggered only if contact is made with that stop.

Many modifications and variations of the present invention are possible in light of the above teachings. It is, therefore, to be understood within the scope of the appended claims the invention may be protected otherwise than as specifically described.

I/We claim:

1. An indicator system for registering a frame on a pallet for use in a printing apparatus comprising:
a pallet support formed from a non-conductive material having a top surface and a lower surface;
a first stop connected to one end of the support, the first stop extending upward from the top surface of the support;
a second stop connected to a second end of the support, the second stop extending upward from the top surface of the support;
a conductive element connecting the first stop and second stop; and,
a first indicator coupled to the second stop.

2. The system of claim 1 wherein the first indicator is an LED.

3. The system of claim 1 wherein the first indicator is an audible alert.

4. The system of claim 1 further comprising a third stop connected to the support proximate the second stop, the third stop extending upward from the top surface of the support and including a second indicator.

5. The system of claim 1 wherein the conductive element is a plate connecting the first stop to the second stop.

6. The system of claim 5 wherein the conductive element is embedded in the support.

7. The system of claim 1 wherein the conductive element is a wire.

8. The system of claim 1 wherein the indicator is connected to the second stop.

9. The system of claim 1 wherein the indicator is remote from the second stop.

10. An indicator system for ensuring proper registration comprising:
a plurality of stops electrically coupled to each other, each stop including a contacting surface for contacting a frame; and,
a first indicator electrically coupled to the stops wherein the first indicator is activated when a complete circuit is made with at least two of the stops and a frame.

11. The system of claim 10 wherein the indicator is a light.

12. The system of claim 10 wherein the indicator is an audible alert.

13. The system of claim 10 wherein the plurality of stops and the first indicator are connected to a printing pallet.

14. The system of claim 10 wherein the plurality of stops and the first indicator are connected to a printing apparatus.

15. A printing apparatus having an indicator system for registering a frame comprising:
a support surface for receiving a frame;
a first stop connected to the support surface;
a second stop connected to the support surface, the second stop electrically coupled to the first stop; and,
a first indicator electrically coupled to the first stop and second stop wherein the indicator is activated when a circuit is created between the first stop, the second stop and a frame.

16. The apparatus of claim 15 further comprising a controller coupled to the apparatus for controlling printing operation, the controller electrically coupled to the stops and configured to prevent a printing operation if the first indicator is not activated.

17. The apparatus of claim of claim 15 wherein the first indicator is a light.

18. The apparatus of claim 15 wherein the first indicator is an audible alert.

19. The apparatus of claim 15 further comprising a third stop electrically coupled to the first stop and a second indicator.

20. The apparatus of claim 16 wherein the controller is coupled to a display and wherein the display functions as the first indicator.
